(19) United States
(12) Patent Application Publication
(10) Pub. No.: US 2017/0342672 A1
(43) Pub. Date: Nov. 30, 2017

(54) LIQUID FEEDER CONTROL SYSTEM

(71) Applicants: Michael Giovinazzo, West Chester, PA (US); Tina Giovinazzo, West Chester, PA (US)

(72) Inventors: Michael Giovinazzo, West Chester, PA (US); Tina Giovinazzo, West Chester, PA (US)

(21) Appl. No.: 15/168,178

(22) Filed: May 30, 2016

(51) Int. Cl. E01H 10/00; B05B 12/08

(52) U.S. Cl. CPC E01H 10/007; B05B 12/087

(57) ABSTRACT

A liquid feeder control system for dispensing a liquid mixture of a preset proportion includes an inlet hose, a pump, a control valve, an outlet hose, a hydraulic pressure switch (HPS), and a fluid pressure switch (FPS). The inlet hose is operably connected to an inlet of the pump and transfers liquid from a liquid storage tank to the pump. The pump pressurizes and releases the liquid to an outlet of the pump. The control valve regulates the flow. The outlet hose is operably connected to the outlet and is in fluid communication with at least one injecting device. The HPS is operably connected to the pump and a material delivery system. The HPS turns off the pump when the material delivery system stops and vice-versa. The FPS is operably connected to the pump for sensing the pressure of the liquid and is operably connected to a visual indicator.

### FIELD OF THE INVENTION

The present disclosure relates in general to feeder systems for salt dispensing vehicles spraying salt with brine on roadways. More particularly, the disclosure relates to liquid feeder control systems for salt dispensing vehicles, which regulate flow of salt brine mixture based on requirement.

### BACKGROUND

Pre-wetting is the process of, for example, spraying deicing salt with a solution of liquid chemical before spreading the salt on a roadway. Pre-wetting the salt helps the salt to work more effectively as a deicing agent. Firstly, wet salt clings to the road instead of bouncing off. The result is that the quantity of salt used is substantially reduced, saving money. Secondly, to be effective as a deicing agent, salt requires moisture. Moisture dissolves the salt, releasing heat and thereby melting the ice and snow. When temperatures drop below freezing there is no moisture on the road, and salt in isolation is ineffective. Pre-wetting the salt ensures that there will be enough moisture to facilitate the melting process. Typically, sodium chloride and water or salt brine, which is a salt and water solution, is used for pre-wetting.

Since brine is what actually melts snow and ice, solid rock salt must first create brine before it goes to work. Road salt (sodium chloride) has an effective temperature range above 20-25 degrees Fahrenheit. At low temperatures, salt has significantly reduced melting capacity. The addition of a liquid chemical to salt enhances its ability to provide safe levels of service by increasing the speed at which salt creates brine to melt snow or ice. Adding liquid chemicals to salt by lowers the “effective” temperature range of the salt. Conventionally, the salt and brine solution is sprayed using a salt spreader truck. The salt is fed into a hopper and the brine solution is stored in a liquid storage tank, which is then sprayed via nozzles onto the salt delivered by a material delivery system. Typically, even if the liquid storage tank is empty, the material delivery system continues to supply salt leading to excessive use of salt. This leads to added costs and unnecessary wastage. A feeder system, which reduces wastage and uneconomical use of salt from the salt dispensing vehicle, is required.

Moreover, conventional salt dispensing vehicles lack a notification feature, which enables an operator to be informed if the system malfunctions. A feeder system, which is capable of notifying an operator when the system malfunctions, is required. Hence, there is a long felt but unresolved need for a feeder system, which reduces wastage and uneconomical use of salt from a salt dispensing vehicle. Furthermore, there is a need for a feeder system, which is capable of notifying an operator when the system malfunctions.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The invention disclosed herein addresses the above-mentioned need for a feeder system, which reduces wastage and uneconomical use of salt from a salt dispensing vehicle. Furthermore, the invention addresses the need for a feeder system, which is capable of notifying an operator when the system malfunctions. The liquid feeder control system for dispensing a liquid mixture of a preset proportion mounted on a vehicle disclosed herein comprises an inlet hose, a pump, a control valve, an outlet hose, a hydraulic pressure switch, and a fluid pressure switch. The inlet hose is operably connected to an inlet of the pump. The inlet hose is in fluid communication with a liquid storage tank. The inlet of the pump is operably connected to the inlet hose for receiving liquid from the liquid storage tank. The pump pressurizes and releases the received liquid to the outlet of the pump. The control valve is operably connected to the outlet of the pump and an outlet hose for regulating the flow of the liquid to the outlet hose. The outlet hose is operably connected to the outlet of the pump via the control valve. The outlet hose is in fluid communication with at least one injecting device. The hydraulic pressure switch is operably connected to the pump and a material delivery system. The hydraulic pressure switch turns off the pump when the material delivery system stops and turns on the pump when the material delivery system starts. The fluid pressure switch is operably connected to the pump for sensing the pressure of the liquid in the pump. The fluid pressure switch is operably connected to a visual indicator positioned in a driver's cabin of the vehicle for notifying the driver if the pressure in the pump drops below a preset point.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a liquid feeder control system for a salt dispensing vehicle.

FIG. 2 exemplarily illustrates a wiring diagram showing the electrical connections of components of a liquid feeder control system.

### DETAILED DESCRIPTION OF THE INVENTION

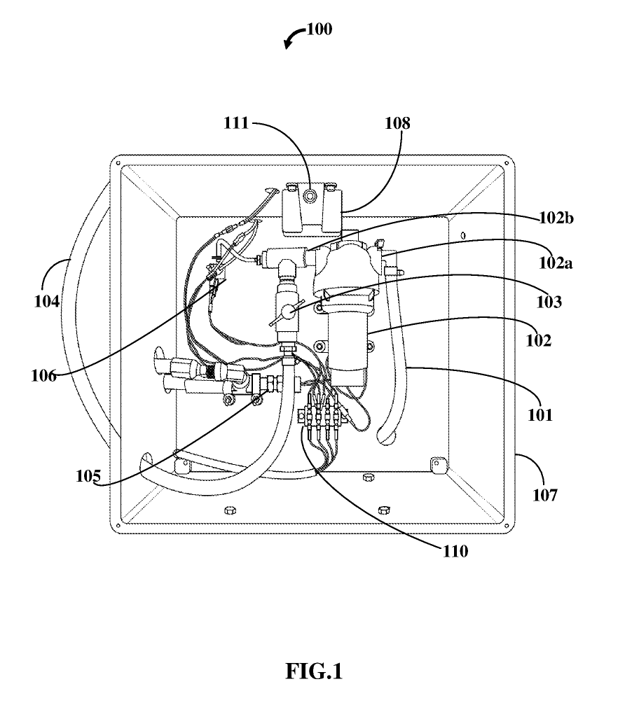

FIG. 1 exemplarily illustrates a liquid feeder control system 100 for a salt dispensing vehicle. In an embodiment, the salt dispensing vehicle is, for example, the vehicle is a salt dispensing truck for dispensing the liquid mixture on a snow-filled roadway. The liquid feeder control system 100 for dispensing a liquid mixture of a preset proportion mounted on a vehicle comprises an inlet hose 101, a pump 102, a control valve 103, an outlet hose 104, a hydraulic pressure switch 105, and a fluid pressure switch 106. In an embodiment, the liquid mixture is, for example, a mixture of salt and brine. The inlet hose 101 is operably connected to an inlet 102a of the pump 102. In an embodiment, the pump 102 used is, for example, a diaphragm pump, etc. As used herein, a “diaphragm pump”, also known as a membrane pump, refers to a positive displacement pump that uses a combination of the reciprocating action of a diaphragm and suitable valves on either side of the diaphragm (check valve, butterfly valves, flap valves, or any other form of shut-off valves) to pump a fluid. The diaphragm is made of, for example, rubber, thermoplastic, Teflon, etc. The valves used are, for example, check valves, butterfly valves, flap valves, other shut-off valves, etc.

With movement of the diaphragm, the volume of a chamber of the diaphragm pump increases, the pressure is decreased, and liquid is drawn into the chamber. When the chamber pressure increases due to reverse movement of the diaphragm, the liquid previously drawn in is forced out. Finally, the diaphragm moving up once again draws liquid into the chamber, completing the cycle. This action is similar to that of the cylinder in an internal combustion engine. In an embodiment, elastomeric diaphragm are used as they do not leak, offer little friction, and can be constructed for low-pressure sensitivity. With the right material consideration, diaphragms can seal over a wide range of pressures and temperatures without needing lubrication or maintenance. The inlet hose 101 is in fluid communication with a liquid storage tank. The inlet 102a of the pump 102 is operably connected to the inlet hose for receiving liquid from the liquid storage tank. The pump 102 pressurizes and releases the received liquid to the outlet 102b of the pump 102. The control valve 103 is operably connected to the outlet 102b of the pump 102 and an outlet hose 104 for regulating the flow of the liquid to the outlet hose 104. In an embodiment, the control valve 103 is, for example, a ball valve.

The outlet hose 104 is operably connected to the outlet 102b of the pump 102 via the control valve 103. The outlet hose 104 is in fluid communication with at least one injecting device. The hydraulic pressure switch 105 is operably connected to the pump 102 and a material delivery system. In an embodiment, the material delivery system is an auger conveying material from a hopper to a passage where the injecting device dispenses the liquid received from the outlet hose 104 of the pump 102. In the embodiment, the material delivered by the material delivery system is salt and the injecting device is, for example, a nozzle.

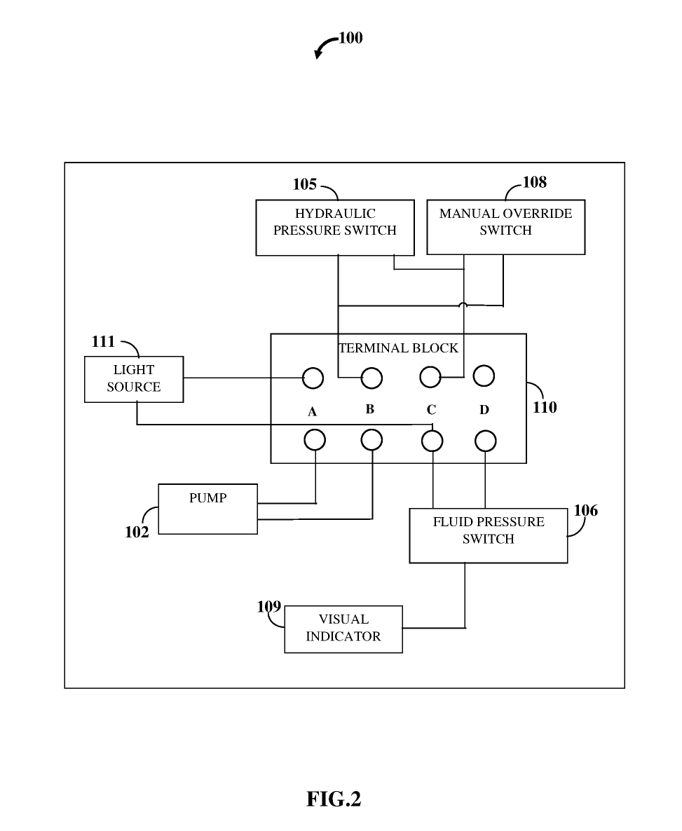

The hydraulic pressure switch 105 turns off the pump 102 when the material delivery system stops and turns on the pump 102 when the material delivery system starts. The fluid pressure switch 106 is operably connected to the pump 102 for sensing the pressure of the liquid in the pump 102. The fluid pressure switch 106 is operably connected to a visual indicator positioned in a driver's cabin of the vehicle for notifying the driver if the pressure in the pump 102 drops below a preset point. In an embodiment, the visual indicator 109 is a light source, for example, an incandescent light source, an LED light source, a neon light source, etc. In an embodiment, the liquid feeder control system 100 is housed in a weatherproof box 107. The weatherproof box 107 is mounted on the salt dispensing vehicle. The visual indicator 109, exemplarily illustrated in FIG. 2, is housed in the cabin of the driver. In an embodiment, the pump 102, the fluid pressure switch 106, the manual override switch 108, and the hydraulic pressure switch 105 are electrically connected to a terminal block 110 as exemplarily illustrated in FIG. 2. In an embodiment, a light source 111 is connected to the terminal block 110 to illuminate the interior of the weatherproof box 107 as exemplarily illustrated in FIG. 2. This enables an operator to view or inspect the components of the liquid feeder control system 100 better.

The liquid feeder control system 100 is controlled by two different pressure settings, for example, the pressure of the liquid in the liquid storage tank and the hydraulic pressure of the auger. When the pressure of the liquid in the pump is low, it means the amount of liquid in the liquid storage tank is lower than the required quantity. The fluid pressure switch 106 senses this lowering of pressure and alerts the driver by actuating the visual indicator 109 housed in the driver's cabin. Additionally, the pump 102 works only when the auger also operates. This ensures the liquid mixture is uniform and the salt dispensing vehicle dispenses only necessary amounts of material, for example, salt. The liquid feeder control system 100 operate in both a manual mode and an automatic mode. In an embodiment, the diaphragm pump is, for example, a pump called a FLORJET®, of FLOW CONTROL LLC LIMITED LIABILITY COMPANY DELAWARE CAPE ANN INDUSTRIAL PARK. The FLORJET® pump draws only 4.4 amps of current and runs off 12 Volt DC power. The maximum flow rate is 2.9 gallons per minute. This pump, producing a suction lift of about 9 ft, is constructed with a triplex diaphragm.

FIG. 2 exemplarily illustrates a wiring diagram showing the electrical connections of components of a liquid feeder control system 100. As disclosed in the detailed description of FIG. 1, the liquid feeder control system 100 comprises an inlet hose 101, a pump 102, a control valve 103, an outlet hose 104, a hydraulic pressure switch 105, and a fluid pressure switch 106. The electrical connections of the liquid feeder control system 100 are as exemplarily illustrated in FIG. 2. When 12V DC is supplied to the terminal block 110, the light source 111 turns on. The light source 111 helps to light up the interior of the weatherproof box 107. 12V DC power is supplied at terminal A of the terminal block 110. Additionally, the pump 102 will not operate unless the manual override switch 108 is turned on. When the manual override switch 108 is in the automatic mode, the pump 102 will not operate until there is pressure at the hydraulic pressure switch 105. The hydraulic pressure switch 105 originates from the hydraulic auger. When the auger stops delivering salt, the pump 102 turns off. When the auger starts, the pump 102 turns on. The fluid pressure switch 106 is used to let the operator know the liquid feeder control system 100 is not operating via the visual indicator 109 in the cabin of the salt dispensing vehicle. The fluid pressure switch 106 senses liquid pressure from the pump 102. If the pump 102 is pumping and has no pressure the visual indicator 109 will turn on inside the cabin. This indicates the liquid storage tank is empty. The visual indicator 109 is not housed in the weatherproof box 107 exemplarily illustrated in FIG. 1. The control valve 103 of the liquid feeder control system 100 is used to control the amount of liquid to be pumped.

The foregoing examples have been provided merely for the purpose of explanation and are in no way to be construed as limiting of the liquid feeder control system 100, disclosed herein. While the liquid feeder control system 100 have been described with reference to various embodiments, it is understood that the words, which have been used herein, are words of description and illustration, rather than words of limitation. Further, although the liquid feeder control system 100, have been described herein with reference to particular means, materials, and embodiments, the liquid feeder control system 100 is not intended to be limited to the particulars disclosed herein; rather, the liquid feeder control system 100 extends to all functionally equivalent structures, methods and uses, such as are within the scope of the appended claims. Those skilled in the art, having the benefit of the teachings of this specification, may effect numerous modifications thereto and changes may be made without departing from the scope and spirit of the liquid feeder control system 100 disclosed herein in their aspects.

1. A liquid feeder control system for dispensing a liquid mixture of a preset proportion mounted on a vehicle, the liquid feeder control system comprising:
an inlet hose operably connected to an inlet of a pump, wherein the inlet hose is in fluid communication with a liquid storage tank;
the pump comprising an inlet and an outlet, the inlet of the pump operably connected to the inlet hose for receiving liquid from the liquid storage tank, wherein the pump pressurizes and releases the received liquid to the outlet of the pump.;
a control valve operably connected to the outlet of the pump and an outlet hose for regulating the flow of the liquid to the outlet hose;
the outlet hose operably connected to the outlet of the pump via the control valve, wherein the outlet hose is in fluid communication with at least one injecting device;
a hydraulic pressure switch operably connected to the pump and a material delivery system, wherein the hydraulic pressure switch turns off the pump when the material delivery system stops, and wherein the hydraulic pressure switch turns on the pump when the material delivery system starts; and
a fluid pressure switch operably connected to the pump for sensing the pressure of the liquid in the pump, wherein the fluid pressure switch is operably connected to a visual indicator positioned in a driver's cabin of the vehicle for notifying the driver if the pressure in the pump drops below a preset point.

2. The liquid feeder control system of claim 1, wherein the liquid mixture is a mixture of brine solution and salt.

3. The liquid feeder control system of claim 1, wherein the vehicle is a salt dispensing truck for dispensing the liquid mixture on a snow-filled roadway.

4. The liquid feeder control system of claim 1, wherein the pump is a diaphragm pump.

5. The liquid feeder control system of claim 1, wherein the injecting device is a nozzle.

6. The liquid feeder control system of claim 1, wherein the material delivery system is an auger conveying material from a hopper to a passage where the injecting device dispenses the liquid from the outlet hose of the pump.

7. The liquid feeder control system of claim 6, wherein the material delivered by the material delivery system is salt.

8. The liquid feeder control system of claim 1, wherein the visual indicator is a light source.

9. The liquid feeder control system of claim 8, wherein the light source is one of an incandescent light source, an LED light source, and a neon light source.

10. The liquid feeder control system of claim 1, wherein the control valve is a ball valve.

11. The liquid feeder control system of claim 1, wherein the liquid feeder control system operates in one of a manual mode and an automatic mode.
